(19) United States
(12) Patent Application Publication
(10) Pub. No.: US 2008/0242121 A1
(43) Pub. Date: Oct. 2, 2008

(54) REDUCED SOCKET SIZE WITH PIN LOCATIONS ARRANGED INTO GROUPS WITH COMPRESSED PIN PITCH

(76) Inventor: David W. Browning, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/694,750

(22) Filed: Mar. 30, 2007

(51) Int. Cl. H01R 12/00

(52) U.S. Cl. 439/65

(57) ABSTRACT

In some embodiments a socket and/or a package includes a plurality of groups of pin locations including at least a first group of pin locations and a second group of pin locations. Each group of pin locations includes a standard pin pitch in a direction between pin locations of the group to allow a maximum breakout from a center of the socket and/or package to an outside of the socket and/or package. Each group of pin locations includes a minimum pin pitch in a direction orthogonal to a direction of the standard pin pitch. Other embodiments are described and claimed.

### TECHNICAL FIELD

The inventions generally relate to reduced socket size with pin locations arranged into groups with compressed pin pitch.

### BACKGROUND

The term “socket” is used to describe a connector between an integrated circuit (IC) and a board. For example, a Central Processing Unit (CPU) socket links a motherboard to a processor. Many CPU sockets and processors use a pin grid array (PGA) architecture in which pins on the underside of the processor are inserted into the socket (for example, using zero insertion force to aid installation). Some sockets use land grid array (LGA) in which pins are on the socket side and come into contact with pads on the processor.

Today's socket arrays use either a uniformly spaced grid of pin locations or two different pin pitches, one for the X-direction and one for the Y-direction. It would be beneficial to obtain socket and/or package size reduction while still providing good breakout routing. Socket and/or package size reduction can be used to reduce costs of the package and/or socket design.

Parquet pin arrangements have previously been implemented in a BGA (Ball Grid Array) arena with the Intel® 915GMS chipset. However, the inventor is not aware of any such arrangement in a socket.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a socket according to some embodiments of the inventions.

FIG. 2 illustrates an arrangement according to some embodiments of the inventions.

FIG. 3 illustrates a socket according to some embodiments of the inventions.

### DETAILED DESCRIPTION

Some embodiments of the inventions relate to reduced socket size with pin locations arranged into groups with compressed pin pitch.

In some embodiments a socket and/or a package includes a plurality of groups of pin locations including at least a first group of pin locations and a second group of pin locations. Each group of pin locations includes a standard pin pitch in a direction between pin locations of the group to allow a maximum breakout from a center of the socket and/or package to an outside of the socket and/or package. Each group of pin locations includes a minimum pin pitch in a direction orthogonal to a direction of the standard pin pitch.

In some embodiments pins of a CPU socket are arranged into four equally sized quadrants. In some embodiments the quadrants are not equal in size. In some embodiments quadrants on opposite sides are equal in size, and/or in some embodiments adjacent quadrants are different in size (for example, in embodiments where a rectangular package is being designed). Pin compression techniques are used to make those quadrants as small as possible without negatively affecting the motherboard routing under the socket.

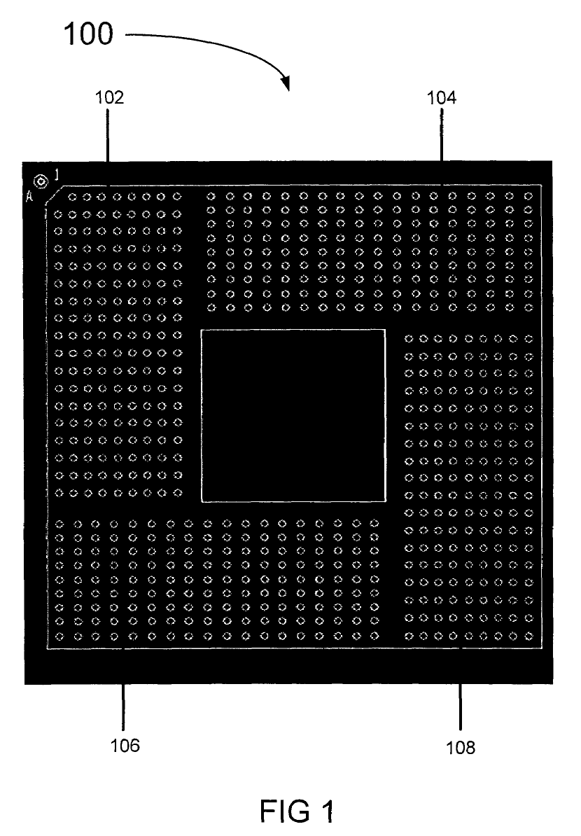

FIG. 1 illustrates a socket 100 according to some embodiments. In some embodiments socket 100 includes four quadrants 102, 104, 106, and 108. In some embodiments four quadrants 102, 104, 106, and 108 are equally sized quadrants, but in some embodiments these quadrants are not equally sized. The pin quadrants 102, 104, 106, and 108 of the socket 100 of FIG. 1 can be described as a “parquet” arrangement.

In some embodiments, within each quadrant of a socket there are two pin pitches, including a standard pin pitch and a minimum pin pitch. The standard pin pitch is chosen to allow the maximum breakout away from the center of the package (or away from the die). In some embodiments the pitch varies depending on the motherboard technologies being used (for example, based on via size, trace space, and/or trace width, etc.)

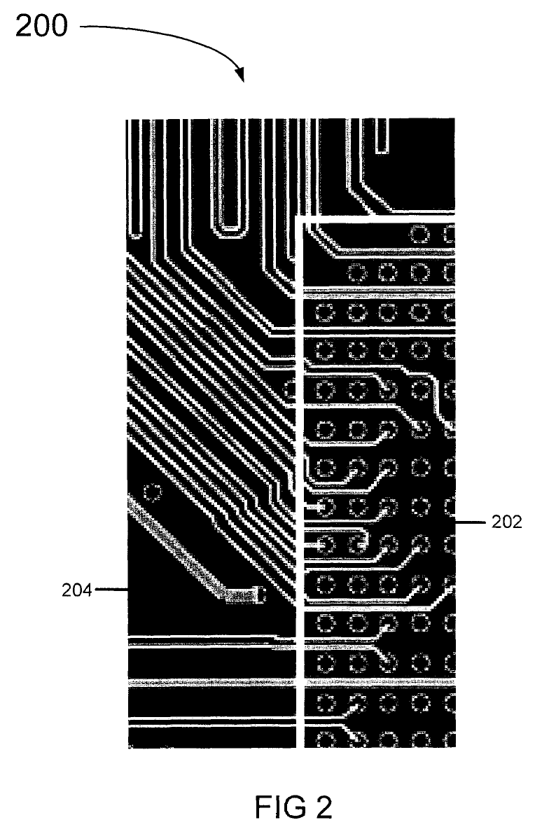

FIG. 2 illustrates an arrangement 200 according to some embodiments. Arrangement 200 illustrates how breakout routing of traces heads away from a package center corresponding to a center of a socket 202 (such as, for example, a socket the same as and/or similar to socket 100 of FIG. 1) and to a motherboard portion 204 outside the socket 202. In some embodiments, as illustrated in FIG. 2, all of the breakout routing is heading away from the package center of the socket 202, and none of the routing needs to travel in a direction orthogonal to the path from the package center heading out to the motherboard 204. This allows for compression of the pin pitch in the other direction (that is, the orthogonal direction) to a minimum value. In some embodiments the minimum value of the pin pitch in the orthogonal direction such that in a rectangle formed by any four adjacent pins, there is room to fit a via on the motherboard 204. This value can be very case specific, varying based on, for example, motherboard pad size for the socket, the via size being used by the motherboard, the allowable space between these different shapes, etc.

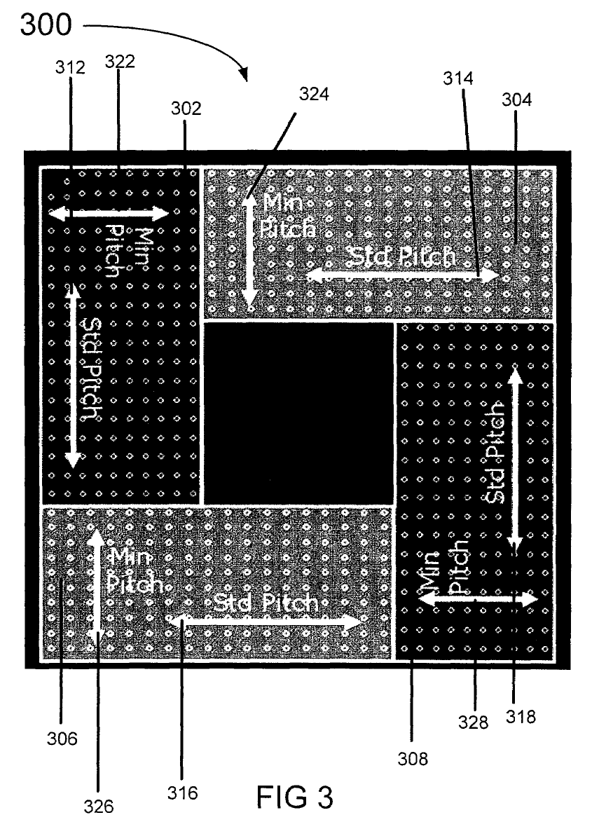

FIG. 3 illustrates a socket 300 according to some embodiments. In some embodiments socket 300 includes four quadrants 302, 304, 306, and 308. In some embodiments four quadrants 302, 304, 306, and 308 are equally sized quadrants. In some embodiments the four quadrants 302, 304, 306, and 308 are not equal in size. The pin quadrants 302, 304, 306, and 308 of the socket 300 of FIG. 3 can be described as a “parquet” arrangement.

In some embodiments, within each quadrant 302, 304, 306, and 308 of socket 300 there are two pin pitches, including a standard pin pitch 312, 314, 316, and 318, and a minimum pin pitch (or orthogonal pin pitch) 322, 324, 326, and 328. The standard pin pitch 312, 314, 316, and 318 is chosen to allow the maximum breakout away from the center of the package (or away from the die). In some embodiments the pitch varies depending on the motherboard technologies being used (for example, based on via size, trace-to-trace spacing, trace-to-via spacing, and/or trace width, etc.)

In some embodiments the minimum pin pitch 322, 324, 326, and 328 is reduced to a minimum value to allow the package to reduce in size. In some embodiments the package reduces in size by a difference between the standard pitch and the minimum pitch multiplied by the number of times the pitch is reduced. For example, for an array of eight pins deep, that yields seven pitches that can be compressed for each quadrant 302, 304, 306, and 308, and two quadrants are opposite from each other. This can result, for example, in a package size savings equal to 14 gaps multiplied by the pitch distance.

Current socket arrays use either a uniformly space grip of pin locations or two different pin pitches for the entire socket, one pin pitch in the X-direction and one pin pitch in the Y-direction. In some embodiments, socket and package reduction is enabled by defining quadrants of pin locations in a parquet (or in a spiral) pattern, and using two different pin pitches within each quadrant (as opposed to applying them across the entire array of pins or pin-holes for the socket).

In some embodiments a package size (and/or a socket size) may be reduced (for example, an integrated circuit package and/or socket size, a processor package and/or socket size, and/or a CPU package and/or socket size, etc.) In some embodiments pin locations (for example, pins and/or pin receptacles) are arranged into a number of portions (for example, into four quadrants) to provide for package reduction in both an X-direction and a Y-direction. The size of the impact of the reduction depends on the amount of pins or pin locations that are being grouped (for example, into four quadrants), and the amount of compression that each group (or quadrant) can utilize.

In some embodiments, for example, a CPU package/socket uses a 1 mm uniform grid array, has eight balls deep on each side, and an open center cavity, resulting in an approximately 37.5 mm wide package size. In some embodiments, a compression pitch is selected of approximately 0.78 mm, reducing the eight pins of each quadrant to decrease their pitch from 1 mm to 0.78 mm. This can provide a 3.08 mm X-direction reduction and a 3.08 mm Y-direction reduction in package size, allowing the 37.5 mm package size to be reduced to approximately 34.5 mm. In this manner, substrate costs may be reduced due to the smaller package size, but the pincount remains the same (therefore, with no loss of features).

In some embodiments, package and/or socket size may be decreased in two directions rather than just in one direction, while still providing good motherboard breakout routing away from the die.

In some embodiments costs of package and/or socket design are reduced by reducing the package and/or socket physical size while maintaining the same feature capabilities (for example, the same pin count).

In some embodiments more pins and/or pin locations are able to fit inside the same package size. In some embodiments a choice may be made between a smaller package and/or socket with the same features, or a same package and/or socket with more features (for example, with more pins and/or pin locations).

Some embodiments have been described herein as having the minimum pitch being reduced to prevent any traces from fitting through a via field in the minimum pitch direction. However, it is noted that in some embodiments the minimum pitch is selected, for example, to allow only a single trace to fit between the via field (for example, instead of two traces). In some embodiments the minimum pitch is selected to prevent any traces from fitting between in that direction. In some embodiments the minimum pitch is selected to allow only one trace to fit between in that direction. In some embodiments, the minimum pitch is selected to allow fewer traces to fit through the minimum pitch distance than can fit through using a standard pitch distance.

Although some embodiments have been described herein as being related to pins of a socket, according to some embodiments these particular implementations may not be required. For example, some embodiments related to pin locations of a socket, where pin locations refers to pins of a socket and/or pin receptacles of a socket, for example, depending on the type of socket, for example.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A socket comprising:
a plurality of groups of pin locations including a first group of pin locations and a second group of pin locations;
wherein each group of pin locations includes a standard pin pitch in a direction between pin locations of the group to allow a maximum breakout from the a center of the socket to an outside of the socket, and wherein each group of pin locations includes a minimum pin pitch in a direction orthogonal to a direction of the standard pin pitch.

2. The socket of claim 1, wherein the pin locations are pins on the socket.

3. The socket of claim 1, wherein the pin location are pin receptacles on the socket.

4. The socket of claim 1, wherein the plurality of groups of pin locations further includes a third group of pin locations and a fourth group of pin locations.

5. The socket of claim 1, wherein the plurality of groups of pin locations are arranged on the socket in a parquet pattern.

6. The socket of claim 4, wherein the plurality of groups of pin locations are arranged on the socket in a parquet pattern.

7. The socket of claim 1, wherein the plurality of groups of pin locations are arranged on the socket in a spiral pattern.

8. The socket of claim 4, wherein the plurality of groups of pin locations are arranged on the socket in a spiral pattern.

9. The socket of claim 1, wherein the minimum pitch allows within any rectangle formed by four adjacent pin locations, room to fit a via on a motherboard.

10. A package comprising:
a plurality of groups of pin locations including a first group of pin locations and a second group of pin locations;
wherein each group of pin locations includes a standard pin pitch in a direction between pin locations of the group to allow a maximum breakout from the a center of the package to an outside of the package, and wherein each group of pin locations includes a minimum pin pitch in a direction orthogonal to a direction of the standard pin pitch.

11. The package of claim 10, wherein the pin locations are pins on the package.

12. The package of claim 10, wherein the pin location are pin receptacles on the package.

13. The package of claim 10, wherein the plurality of groups of pin locations further includes a third group of pin locations and a fourth group of pin locations.

14. The package of claim 10, wherein the plurality of groups of pin locations are arranged on the package in a parquet pattern.

15. The package of claim 10, wherein the minimum pitch allows within any rectangle formed by four adjacent pin locations, room to fit a via on a motherboard.
